(19) United States
(12) Patent Application Publication
(10) Pub. No.: US 2015/0269373 A1
(43) Pub. Date: Sep. 24, 2015

(54) STRUCTURE OF SECURITY AUTHENTICATION DEVICE

(71) Applicant: SMARTCHIP MICROELECTRONICS CORP., New Taipei City (TW)

(72) Inventor: Cheng-Tsung Tsai, New Taipei City (TW)

(73) Assignee: SMARTCHIP MICROELECTRONICS CORP., New Taipei City (TW)

(21) Appl. No.: 14/223,608

(22) Filed: Mar. 24, 2014

(51) Int. Cl. G06F 21/34

(52) U.S. Cl. CPC G06F 21/34

(57) ABSTRACT

A structure of an authentication device main includes a smart device and the authentication device having a plug terminal inserted into and connected to an audio jack of the smart device. An audio converting module converts data, stored in a data storage module, into an audio authentication signal transferred to the smart device. The smart device converts the audio authentication signal into a digital password through application software. An operation of the smart device is directly performed by automatically inputting authentication data.

### BACKGROUND OF THE INVENTION

(1) Field of the Invention

The invention relates in general to a structure of a security authentication device, and more particularly to a device for directly operating a smart device by automatically inputting authentication data.

(2) Description of the Prior Art

The development of cloud technology is not only the future trend, but also one of the indispensable elements of the future life. The rapid development of the cloud brings unprecedented convenience to the people in the aspect, such as the operation interface service linking to the website, the e-mail access, the cloud database, the cloud financial transaction, the cloud storage space, the access to a membership-based specific website, the on-line game or the like. In addition, due to the popularity of smart devices, the efficiency of the use of the cloud is significantly enhanced. When the above actions are to be carried out on the cloud, in order to protect personal privacy and data transmission security, authentication information, such as the account name, password, security code, identification code, telephone number, communication protocol code or the like, has to be inputted before entering the specific webpage operation interface, the cloud database, the cloud financial transaction interface, the cloud storage space or the e-mail access. Each user has to remember the account name, password, security code, identification code, telephone number or communication protocol code for every webpage operation interface, cloud database, cloud financial transaction interface, e-mail, membership-based specific website, online game and cloud storage space. In addition, the tedious steps for the so-called membership registration, authentication and creating of the account passwords, and the like have to be carried out before the first use. In addition, because the page systems of the clouds differ from one another, considerable inconvenience and distress are brought to the users. Furthermore, for the users who are not familiar with the cloud interface operations, the difficulty in use is further increased.

Therefore, how to solve the above-mentioned drawbacks and problems is an issue for the present invention.

### SUMMARY OF THE INVENTION

A main object of the invention is to provide a structure of a security authentication device mainly composed of a smart device and an authentication device, which has a plug terminal inserted into and connected to an audio jack of the smart device. An audio converting module converts data, stored in a data storage module, into an audio authentication signal transferred to the smart device. The smart device converts the audio authentication signal into a digital password through the application software. Thus, the operation of the smart device is directly performed by automatically inputting the authentication data.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial view of the invention.

FIG. 2 is a first schematic partial view of the invention.

FIG. 3 is a second schematic partial view of the invention.

FIG. 4 is a schematic block diagram showing an embodiment of the invention.

### DETAILED DESCRIPTION OF THE PREFERRED EMBODIMENTS

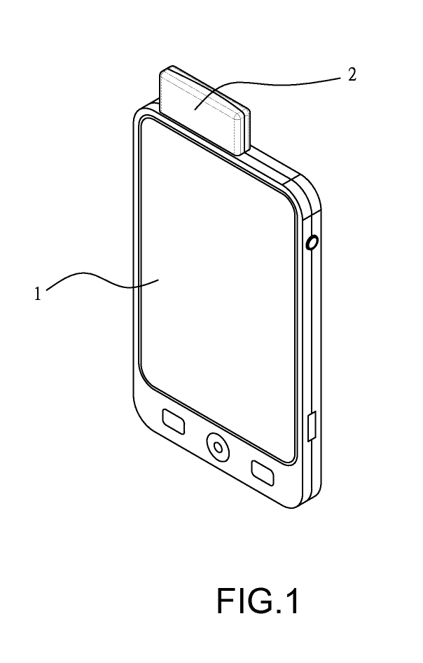

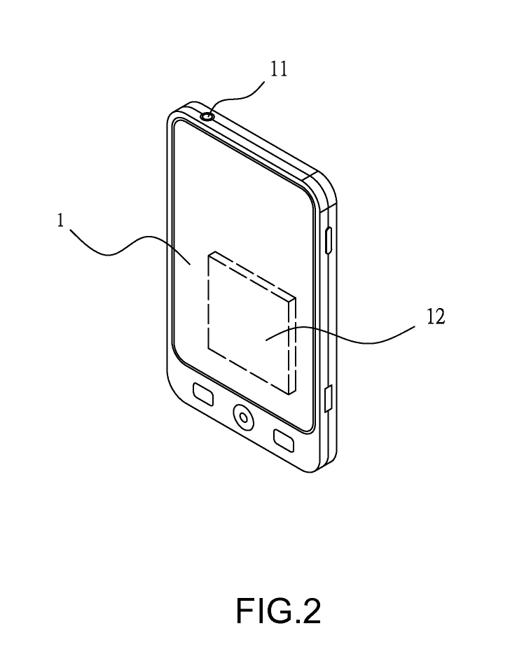

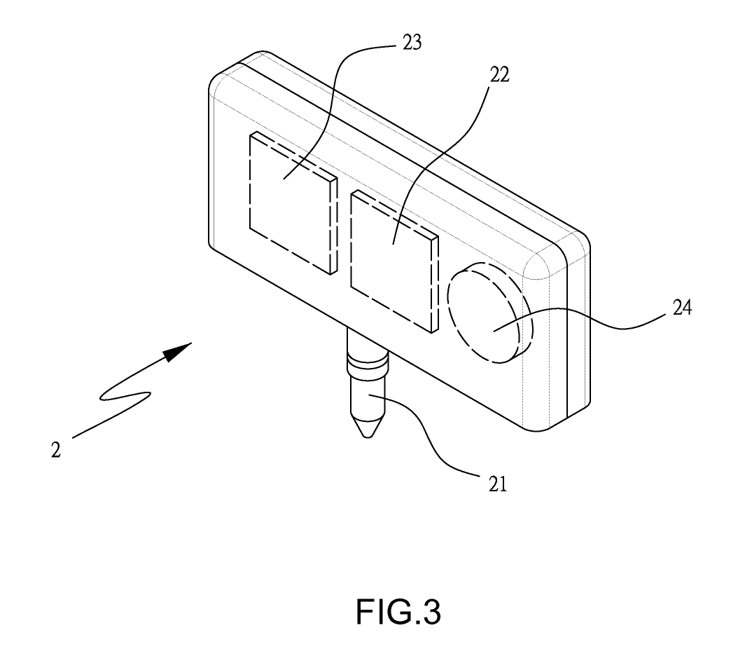

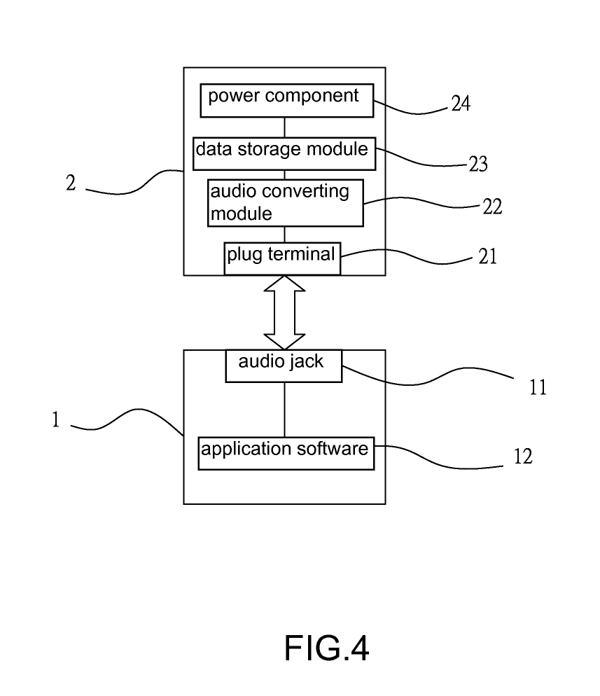

FIGS. 1 to 4 are a pictorial view, schematic partial views and a schematic block diagram according to the embodiment of the invention.

As shown in FIGS. 1 to 4, the invention mainly includes a smart device 1 and an authentication device 2.

The smart device 1 has one side formed with an audio jack 11 and is installed with application software 12. The smart device 1 is a smart mobile phone, a tablet computer, a desktop computer, a notebook computer or a personal digital assistant (PDA) with a network accessing function.

The authentication device 2 is mainly composed of a plug terminal 21, an audio converting module 22 and a data storage module 23, and is inserted into and connected to the audio jack 11 of the smart device 1 through the plug terminal 21. The authentication device 2 also has a power component 24 for providing electric power for the authentication device 2.

The audio jack 11 of the authentication device 2 is inserted into and connected to the audio jack 11 of the smart device 1. After the user gets the connection to the cloud through the network accessing function of the smart device 1, the audio converting module 22 converts the data, stored in the data storage module 23, into audio authentication signals with different frequencies, periods, amplitudes and phases, while performing an encrypting process concurrently. The signals are transferred to the smart device 1 through the plug terminal 21. After the smart device 1 receives the audio authentication signal, the application software 12 of the smart device 1 performs the interpretation and converts the audio authentication signals with different frequencies, periods, amplitudes and phases into a digital password. When the user wants to access the webpage operation interface, cloud database, cloud financial transaction interface, e-mail, cloud storage space, online game or membership-based specific website, the digital password is directly inputted as the information, such as the account name, password, security code, identification code, telephone number, communication protocol code or the like, so that various operations can be directly performed on the cloud.

The data storage module 23 mainly stores the authentication data that needs to be inputted when the user wants to access the webpage operation interface, cloud database, cloud financial transaction interface, e-mail, cloud storage space, online game or membership-based specific website. Also, the user can modify the authentication data through the smart device 1, or even can specify to automatically input the corresponding authentication data, such as the account name, password, security code, identification code, telephone number, communication protocol code or the like, when the user wants to access the different webpage operation interfaces, cloud databases, cloud financial transaction interfaces, e-mails, cloud storage spaces, online games or specific websites. Basically, the authentication device 2 has the reading and writing functions. However, if the authentication device 2 is sold or provided by the service provider of the cloud database, cloud financial transaction interface, e-mail, cloud storage space, online game or specific website, then the service provider can perform the setting that the user only can read but cannot modify the authentication data.

In addition, before the user firstly uses the webpage operation interface, cloud database, cloud financial transaction interface, e-mail, cloud storage space, online game or membership-based specific website, the steps of registering, identification authentication, account password creating and the like need to be performed. Therefore, the provision of the authentication device 2 also makes it possible for the user to perform the complicated steps. The data storage module 23 of the authentication device 2 contains the created virtual account, so that various operations of accessing the webpage operation interface, cloud database, cloud financial transaction interface, e-mail, cloud storage space, online game or membership-based specific website can be performed on the cloud after the user inserts the authentication device 2 into the smart device 1.

In addition to the authentication information, required to access the specific webpage operation interface, cloud database, cloud financial transaction interface, e-mail, cloud storage space, online game or membership-based specific website, the authentication device 2 may also store the website linking addresses for the specific webpage operation interface, cloud database, cloud financial transaction interface, e-mail, cloud storage space, online game or membership-based specific website. After the user connects the authentication device 2 to the smart device 1, the specific webpage operation interface, cloud database, cloud financial transaction interface, e-mail page, cloud storage space, online game or membership-based specific website can be accessed, and the user can link to the desired cloud space more rapidly.

In addition, it is to be specified that because the data storage space and the memory of the smart device 1 are limited, the authentication device 2 can directly provide a created cloud storage space for the user. After the user connects the authentication device 2 to the smart device 1, the data accessing can be performed through the provided cloud storage space.

In summary, compared with the conventional behavior of accessing the operation interface service of the linked webpage, e-mail, cloud database, cloud monetary transaction, cloud storage space, online game or membership-based specific website, in which the user has to disadvantageously input the authentication code, password or account, the invention has the following advantages. The invention uses the authentication device 2 so that the smart device 1 can rapidly enter the webpage operation interface service, e-mail, cloud database, cloud monetary transaction, cloud storage space, online game or membership-based specific website to perform various operations without requesting the user to input the account name, password, security code, identification code, telephone number or communication protocol code.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A structure of a security authentication device, comprising:
a smart device, which has one side formed with an audio jack and is installed with application software; and
an authentication device, which is mainly composed of a plug terminal, a audio converting module and a data storage module, and is inserted into and connected to the audio jack of the smart device through the plug terminal, wherein:
the plug terminal of the authentication device is inserted into and connected to the audio jack of the smart device;
the audio converting module converts authentication data, stored in the data storage module, into an audio authentication signal transferred to the smart device; and
the smart device converts the audio authentication signal into a digital password through the application software, so that an operation of the smart device is directly performed by automatically inputting the authentication data.

2. The structure according to claim 1, wherein the smart device is one of a smart mobile phone, a tablet computer, a desktop computer, a notebook computer and a personal digital assistant (PDA).

3. The structure according to claim 1, wherein the authentication device further comprises a power component.

4. The structure according to claim 1, wherein when the audio converting module is converting the authentication data, stored in the data storage module, into the audio authentication signal, the audio converting module also performs an encrypting process concurrently.

5. The structure according to claim 1, wherein the audio converting module converts data, stored in the data storage module, into audio authentication signals with different frequencies, periods, amplitudes and phases.
